(19) United States
(12) Patent Application Publication
(10) Pub. No.: US 2023/0304329 A1
(43) Pub. Date: Sep. 28, 2023

(54) POSITION SENSING SYSTEM FOR A LATCH USING A COMMON SENSOR

(71) Applicant: Magna Automotive Parts (Suzhou) Co., Ltd., Suzhou Jiangsu (CN)

(72) Inventors: Jianjun YU, Suzhou Jiangsu (CN); Chris HUANG, Suzhou Jiangsu (CN); Young XUE, Suzhou Jiangsu (CN); Francesco CUMBO, Newmarket (CA)

(21) Appl. No.: 18/113,733

(22) Filed: Feb. 24, 2023

(30) Foreign Application Priority Data
Feb. 24, 2022 (CN) 202210175155.3

(51) Int. Cl. E05B 81/66; E05B 81/06; E05B 85/26

(52) U.S. Cl. CPC E05B 81/66; E05B 81/06; E05B 85/26; E05B 81/18

(57) ABSTRACT

A latch for a closure panel of a vehicle comprising: a housing; a ratchet pivotally mounted the housing for moving between an open position and a primary position; a pawl pivotally mounted on the housing, the pawl biased towards the ratchet for holding the ratchet in a secondary position and in the primary position, the secondary position located between the open position and the primary position; and a position sensor for detecting a first position of the ratchet when at the primary position as well as a second position when the ratchet is at the secondary position.

### CROSS-REFERENCE TO RELATED APPLICATION

This application claims the benefit and priority of Chinese Patent Application No. 202210175155.3 filed on Feb. 24, 2022. The entire disclosure of the above application is incorporated herein by reference.

### FIELD OF THE INVENTION

This present invention relates to latch operation for vehicle closure panels.

### BACKGROUND

A typical motor vehicle door is mounted in a door frame on the vehicle and is movable between open and closed positions. Usually the door is held in a closed position by the latching engagement between a spring-biased ratchet pivotally mounted inside the door latch and a U-shaped striker secured to the door frame. The ratchet is most often spring-biased toward the unlatched position to release the striker and is maintained in the latched position to hold the striker by a spring-biased pawl or other mechanical structure. The ratchet cannot pivot to release the striker until the pawl is moved.

Power assisted door latch assemblies have been developed to overcome the problems associated with latching doors with lightweight construction and hard door seals. Power assisted door latch assemblies allow low internal energy or soft closure of lightweight doors without the need to slam the door even with the increased seal pressure that results from relatively hard door seals.

However, current problems exist with powered latch assemblies, including complicated latch component configurations and large and inconvenient assembly footprints. Further, when using a power cinching latch, it can be complicated to provide straightforward and reliable position detection for the cinching operation. Current state of the position sensors can provide for position sensing, however these multiple sensor systems can be expensive and hard to package in a vehicle closure panel system. Further, multiple sensor configurations can be more complicated to configure and operate for multiple different latch geometries based on different latch versions (i.e. placement and spacing between multiple sensors must be custom calibrated for each latch type).

### SUMMARY

It is an object to the present invention to provide a position detection system or method to obviate or mitigate at least one of the above-mentioned problems.

A first aspect provided is a latch for a closure panel of a vehicle comprising: a housing; a ratchet pivotally mounted the housing for moving between an open position and a primary position; a pawl pivotally mounted on the housing, the pawl biased towards the ratchet for holding the ratchet in a secondary position and in the primary position, the secondary position located between the open position and the primary position; and a position sensor for detecting a first position of the ratchet when at the primary position as well as a second position when the ratchet is at the secondary position.

A second aspect provided is a method for operating a latch of a vehicle closure panel, the latch having a position sensor, the method comprising the steps of: using the position sensor to sense a secondary position of a ratchet of the latch; and using the same sensor to sense a primary position of the ratchet.

### BRIEF DESCRIPTION OF THE DRAWINGS

The foregoing and other aspects will be more readily appreciated having reference to the drawings, wherein:

FIG. 1a is a perspective view of an example vehicle;

FIG. 1b is a perspective view of a further example of a vehicle;

FIGS. 2a and 2b show an example latch mechanism in a latched configuration for the vehicle of FIG. 1a;

FIGS. 3a,b,c,d show details of operation of a position sensor of FIG. 2a for various positions of a ratchet of the latch;

FIG. 4 shows example switch positions of the position sensor of FIG. 2a;

FIG. 5 shows various position sensor states based on the switch positions of the switch of FIG. 2a;

FIGS. 6a, 6a show movement between the pawl and ratchet components of the latch mechanism of FIG. 2a;

FIG. 7 shows a plurality of different latch modes and switch states for the latch of FIG. 2a;

FIG. 8 shows an example embodiment of the position detection system of the vehicle of FIG. 1a for the example latch configuration of FIG. 2a; and

FIG. 9 shows an example operation for the position detection system of FIG. 8.

### DESCRIPTION

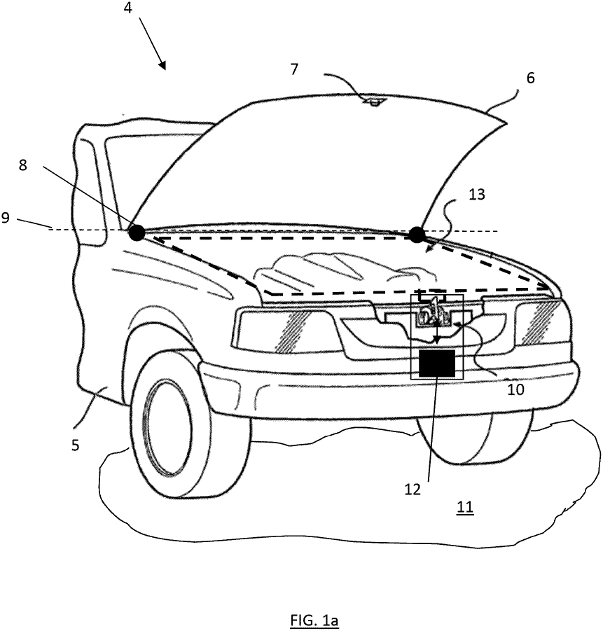

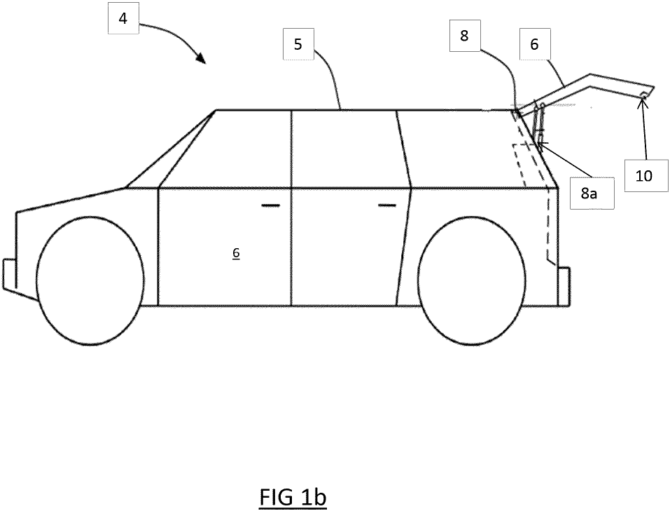

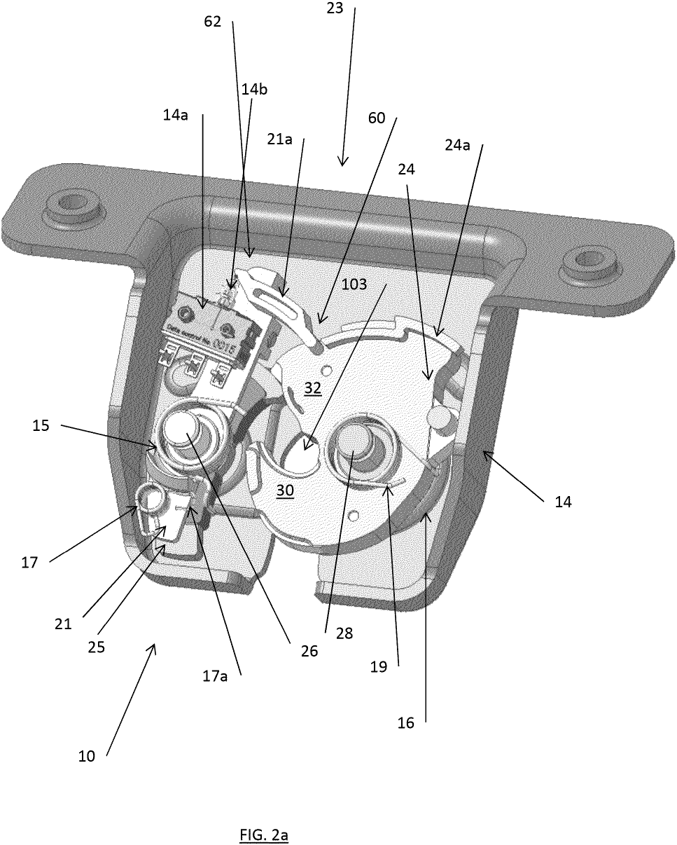

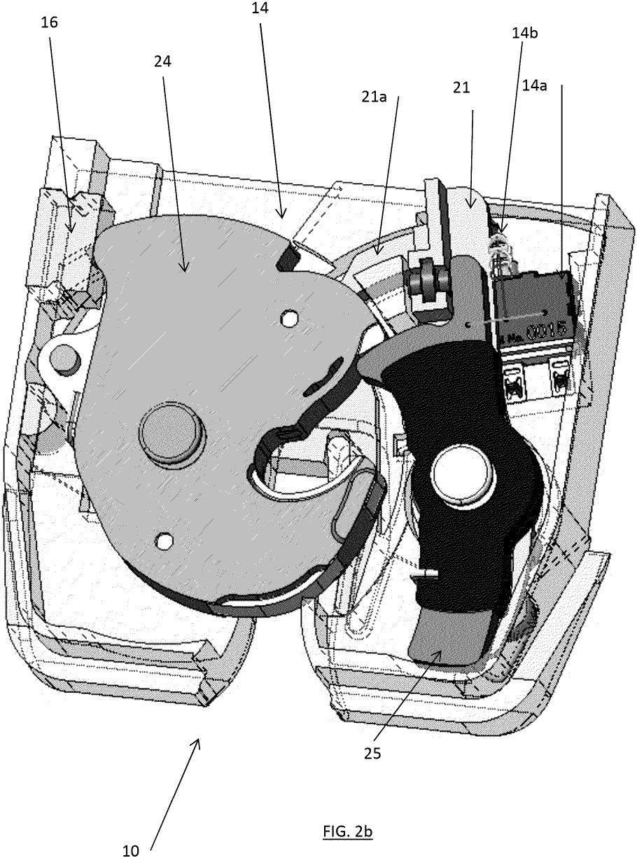

Referring to FIG. 1a, shown is a vehicle 4 with a vehicle body 5 having one or more closure panels 6 coupled to the vehicle body 5. The closure panel 6 is connected to the vehicle body 5 via one or more hinges 8 and a latch 10 (e.g. for retaining the closure panel 6 in a closed position once closed - such as a cinch latched primary position) (shown in dashed outline). The closure panel 6 has a mating latch component 7 (e.g. striker) mounted thereon for coupling with the latch 10 mounted on the vehicle body 5. Alternatively, latch 10 can be mounted on the closure panel 6 and the mating latch component 7 mounted on the body 5 (not shown). For example, the latch 10 can have a ratchet 24 (see FIG. 2) for retaining a striker 7 between a striker releasing position corresponding to an open position of the closure panel 6 and a secondary striker capture position corresponding to a partially closed position (e.g. secondary position) of the closure panel 6. Further, the ratchet 24 can be configured for having a primary striker capture position corresponding to a fully closed position of the closure panel 6 (e.g. a latched or primary position).

Referring to FIG. 1b, shown is the vehicle 4 with the vehicle body 5 having an alternative embodiment of the one or more closure panels 6 coupled to the vehicle body 5, including one or more struts 8a (e.g. power actuated struts 8a). The closure panel 6 is connected to the vehicle body 5 via one or more hinges 8 and latch 10 (e.g. for retaining the closure panel 6 in a closed position once closed). It is recognized that examples of the closure panel 6 can include a hood panel, a door panel, a hatch panel and other panels as desired.

In the embodiment shown, the closure panel 6 pivots between the open panel position and the closed panel position about a pivot axis 9 (e.g. of the hinge 8), which can be configured as horizontal or otherwise parallel to a support surface 11 of the vehicle 4. In other embodiments, the pivot axis 9 may have some other orientation such as vertical or otherwise extending at an angle outwards from the support surface 11 of the vehicle 4. In still other embodiments, the closure panel 6 may move in a manner other than pivoting, for example, the closure panel 6 may translate along a predefined track or may undergo a combination of translation and rotation between the open and closed panel positions, such that the hinge 8 includes both pivot and translational components (not shown). As can be appreciated, the closure panel 6 can be embodied, for example, as a hood, passenger door, or lift gate (otherwise referred to as a hatch) of the vehicle 4.

For vehicles 4 in general, the closure panel 6 can be referred to as a partition or door, typically hinged, but sometimes attached by other mechanisms such as tracks, in front of an opening 13 which can be used for entering and exiting the vehicle 4 interior by people and/or cargo. It is also recognized that the closure panel 6 can be used as an access panel for vehicle 4 systems such as engine compartments and also for traditional trunk compartments of automotive type vehicles 4. The closure panel 6 can be opened to provide access to opening, or closed to secure or otherwise restrict access to the opening 13. It is also recognized that there can be one or more intermediate open positions (e.g. unlatched position) of the closure panel 6 between a fully open panel position (e.g. unlatched position) and fully closed panel position (e.g. latched position), as provided at least in part by the hinges 8 and latch 10, as assisted by the power latch system 12. For example, the power latch system 12 can be used to provide an opening force (or torque) and/or a closing force (or torque) for the closure panel 6.

Movement of the closure panel 6 (e.g. between the open and closed panel positions) can be electronically and/or manually operated, where power assisted closure panels 6 can be found on minivans, high-end cars, or sport utility vehicles (SUVs) and the like. As such, it is recognized that movement of the closure panel 6 can be manual or power assisted during operation of the closure panel 6 at, for example: between fully closed (e.g. locked or latched) and fully open (e.g. unlocked or unlatched); between locked/latched and partially open (e.g. unlocked or unlatched); and/or between partially open (e.g. unlocked or unlatched) and fully open (e.g. unlocked or unlatched). It is recognized that the partially open configuration of the closure panel 6 can also include a secondary lock (e.g. closure panel 6 has a primary lock configuration at fully closed and a secondary lock configuration at partially open - for example for latches 10 associated with vehicle hoods).

In terms of vehicles 4, the closure panel 6 may be a hood, a lift gate, or it may be some other kind of closure panel 6, such as an upward-swinging vehicle door (i.e. what is sometimes referred to as a gull-wing door) or a conventional type of door that is hinged at a front-facing or back-facing edge of the door, and so allows the door to swing (or slide) away from (or towards) the opening 13 in the body 5 of the vehicle 4. Also contemplated are sliding door embodiments of the closure panel 6 and canopy door embodiments of the closure panel 6, such that sliding doors can be a type of door that open by sliding horizontally or vertically, whereby the door is either mounted on, or suspended from a track that provides for a larger opening 13 for equipment to be loaded and unloaded through the opening 13 without obstructing access. Canopy doors are a type of door that sits on top of the vehicle 4 and lifts up in some way, to provide access for vehicle passengers via the opening 13 (e.g. car canopy, aircraft canopy, etc.). Canopy doors can be connected (e.g. hinged at a defined pivot axis and/or connected for travel along a track) to the body 5 of the vehicle at the front, side or back of the door, as the application permits. It is recognized that the body 5 can be represented as a body panel of the vehicle 4, a frame of the vehicle 4, and/or a combination frame and body panel assembly, as desired.

Referring to FIGS. 2a, 2b, also provided is a power latch 10 (also referred to as latch 10 or elatch 10), as further described below. The power latch 10 is configured for actuating the operation of the closure panel between the open position and the primary (or closed) position. In this manner, the power latch 10 can be used to forcefully provide, during deployment, some form of force assisted open operation (e.g. full open, partial open, etc.) of the closure panel 6 and/or some form of force assisted close operation (e.g. full open, partial open, etc.) of the closure panel 6, for example as provided as a cinching operation in order to move the closure panel 6 to a fully closed position.

Referring to FIGS. 2a, 2b, shown is an example power latch assembly 12 having a frame 14, a rotary actuator system 16 (containing one or more motors / actuators coupled to a ratchet 24 and a pawl 25) mounted on the frame 14. The power latch 10 can be coupled to the body 5. The latch 10 is oriented on the frame 14 so as to be aligned to engage the mating latch component 7 (e.g. striker 7). The rotary actuator system 16 is coupled to one or more latch components 23 (e.g. ratchet 24 and/or pawl 25), in order to assist movement of the ratchet 24 from the primary position (e.g. cinched or closed position) and secondary positions (e.g. to activate the pawl 25 in order to facilitate movement of the ratchet 24 from the primary to the secondary position, as well as to move the ratchet 24 in order to move the latch status of the latch 10 from the secondary to the primary or cinched position).

Latch elements 23 of the ratchet 24 and pawl 25 are pivotally secured to the frame plate 14 via respective shafts 28, 26. The ratchet 24 includes an arm 30 and an arm 32 spaced apart to define a generally u-shaped slot 103 there between (e.g. a hook of arm 30 and a lip of arm 32 that extends laterally beyond the hook). Note that in FIG. 2a the latch 10 with associated ratchet 24 is shown in the fully or primary closed position (e.g. facilitating the retention of the mating latch component 7 within the slot 103).

Referring to FIG. 2a, the latch components 23 can include a number of biasing elements 15, 17, 19 (for example springs), such as ratchet biasing element 19 that biases rotation of the ratchet 24 about the shaft 28 to drive the mating latch component 7 out of the slot 103 (thus moving the closure panel 6 towards the open position from the secondary position), pawl biasing element 15 that biases rotation of the pawl 25 about the shaft 26 to retain the ratchet 24 in the closed position (i.e. restrict rotation of the ratchet 24 about the shaft 28 under the influence of the ratchet biasing element 19), and a pawl lever element 17 (e.g. spring) that can provide friction to influence rotation of a pawl lever 21 (also about the pivot 26) by a spring leg 17a contact with the pawl lever 21 to provide friction to facilitate that the pawl lever 21 is stable and thus inhibits rotation of the pawl lever 21 with the pawl 25 towards the release direction of the latch 10.

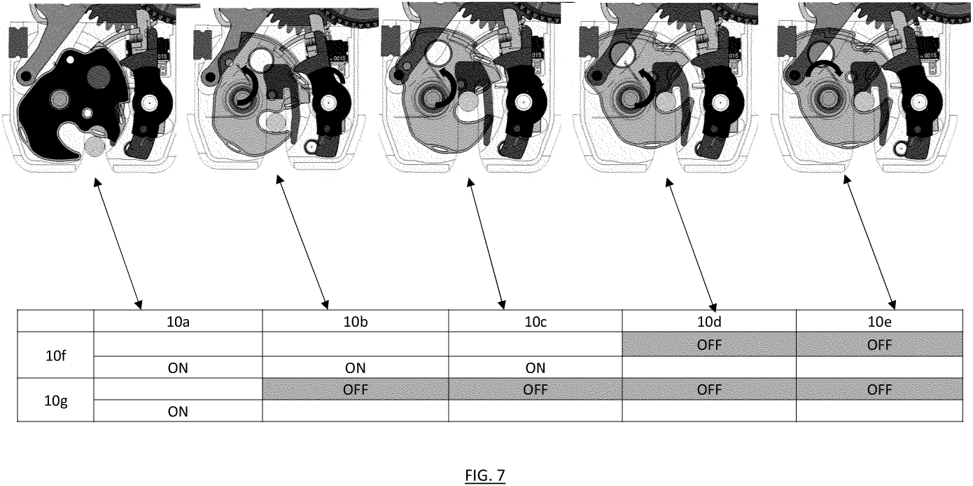

Further, the patch 10 also has a position sensor 14a (e.g. mounted on the frame 14) having a multi position switch 14b (e.g. position OP1 and position OP2 as further described below - see FIG. 7). The pawl lever 21 has a cam lever arm 21a, which is positioned at one end 60 adjacent to a cam surface 24a of the ratchet 24 and at the other end 62 to the switch 41b. As such, as further described below, movement of the end 60 against the cam surface 24a causes the end 62 to activate varying positions of the switch 14b, as further described below. For example, the multi position switch 14b can be exposed to operation of the power latch 10 by employing a method when opening/closing the closure panel 6 to advantageously utilize the same sensor / switch combination multiple times when the latch 10 elements move, such as by: using the position sensor 14a to sense a secondary position of the ratchet 24 of the latch 10; and using the same sensor 14a to sense a primary position of the ratchet 24.

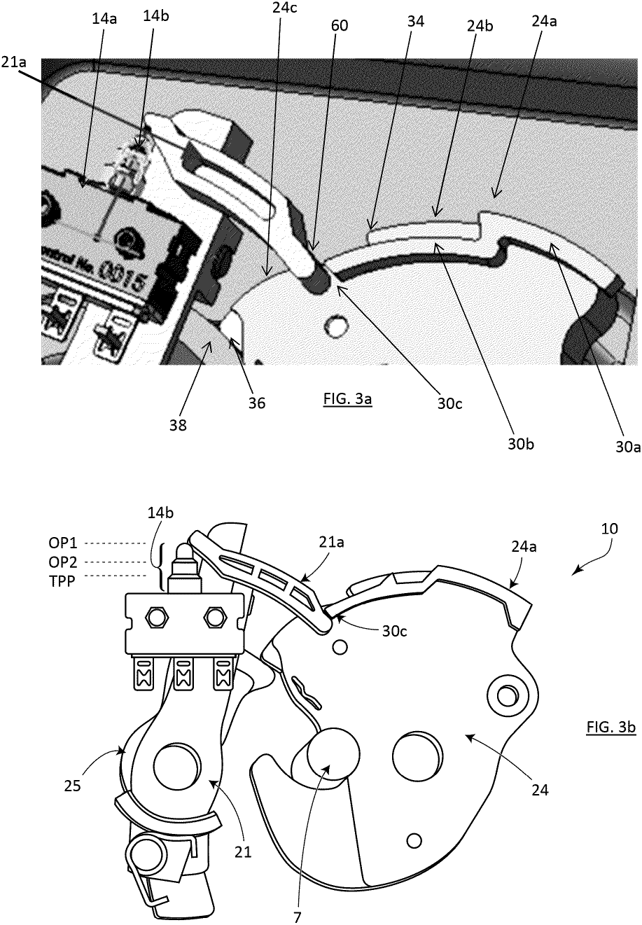

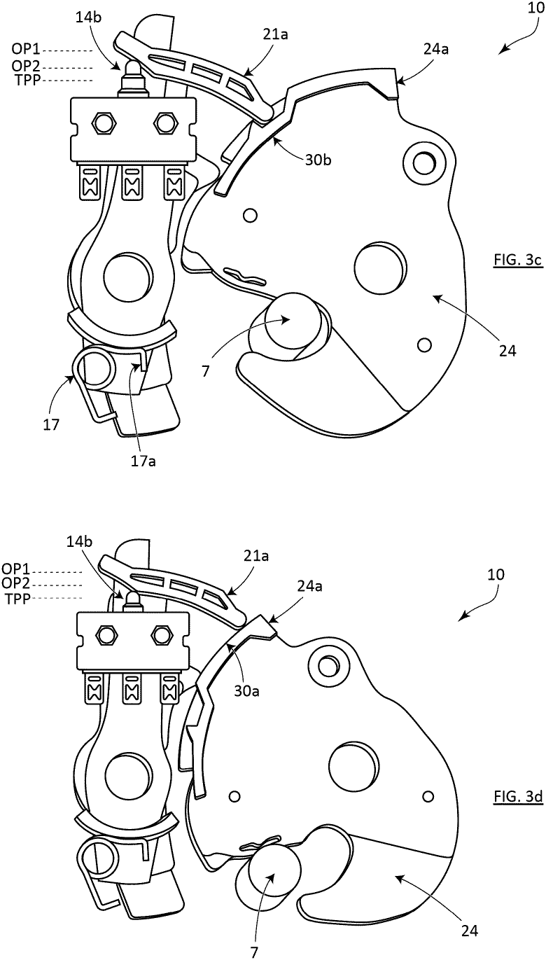

Further, the pawl 25 has an abutment 38 for engaging with a notch 34 of a ratchet surface 24b (of the ratchet 24 on a peripheral edge) when it is at the secondary position and with notch 36 of the ratchet surface 24b when the ratchet 24 is at the primary position (e.g. cinched position), see FIG. 3a. Also, it is recognised that the ratchet surface 24b has a cam ratchet portion 24c situated between the notches 34, 36, as further described below.

Referring to FIG. 3a, the cam surface 24a has a plurality of surface portions 30a, 30b, 30c, such that each of the portions 30a, 30b, 30c corresponds with a state (OP1, OP2, TTP) of the switch 14b (e.g. shared switch 14b for the same cam surface 24a). For example, state OP1 corresponds with the latch 10 being in the primary position - see FIG. 3b, such that the cam lever arm 21a is at surface portion 30c of the cam surface 24a. For example, state OP2 corresponds with the latch 10 being in the secondary position - see FIG. 3c, such that the cam lever arm 21a is at surface portion 30b of the cam surface 24a. For example, state TPP corresponds with the latch 10 being in the open position - see FIG. 3d, such that the cam lever arm 21a is at surface portion 30a of the cam surface 24a.

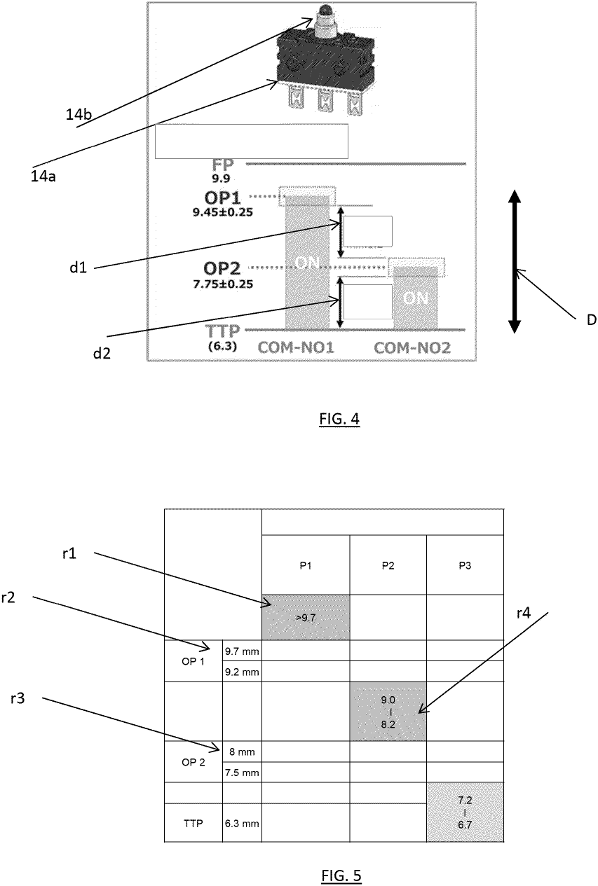

Referring to FIG. 4, shown is an example embodiment of the different states OP1, OP2, TPP of the switch 14b, represented as differing depths of travel D (e.g. middle travel d1 and over travel d2, such as by example travel measuring 1.2) with respect to the sensor body 14a, such that state OP1 represents the travel D furthest away from the sensor body 14a and state TTP represents the travel D closest to the sensor body 14a. In any event, it is recognised that the position of the end 62 with respect to the switch 14b causes the switch 14b to move between the various states OP1, OP2, TPP, as the end 60 follows the various surface portions 30a, 30b, 30c of the cam surface 24a, as the ratchet 24 rotates about the pivot 28. Further, referring to FIG. 2a, it is recognised that the pawl biasing element 15 (in cooperation with the friction provided by the lever spring element 17) provides a bias to the end 60 of the cam lever arm 21a, such that the end 60 follows the cam surface 24a as the ratchet 24 rotates about the pivot 28.

Further, it is recognised that the pawl lever 21 can rotate about the pivot 26 relative to the rotation of the pawl 25, in order to facilitate travel of the end 60 along the cam surface 24a. For example, the pawl biasing element 15 (in cooperation with the friction provided by the lever spring element 17) provides a bias to the end 60 of the cam lever arm 21a, such that the end 60 is biased to move towards the surface portion 30a and then towards the surface portion 30b while the abutment 38 moves along the ratchet surface 24b and into notch 34 (e.g. end 60 simultaneously changes from cam portion 30a to cam portion 30b when the abutment 38 moves into the notch 34, such that the pawl lever 21 and the pawl 25 rotate about the pivot 26 together in response to the bias provided by the pawl bias element 15). Similarly, the end 60 is biased to move towards the surface portion 30b and towards the surface portion 30c while the abutment 38 moves along the ratchet cam portion 24c and into notch 36 (e.g. end 60 simultaneously changes from cam portion 30b to cam portion 30c when the abutment 38 moves from the ratchet cam portion 24c and into the notch 36, such that the pawl lever 21 and the pawl 25 rotate about the pivot 26 with the bias provided by the pawl bias element 15).

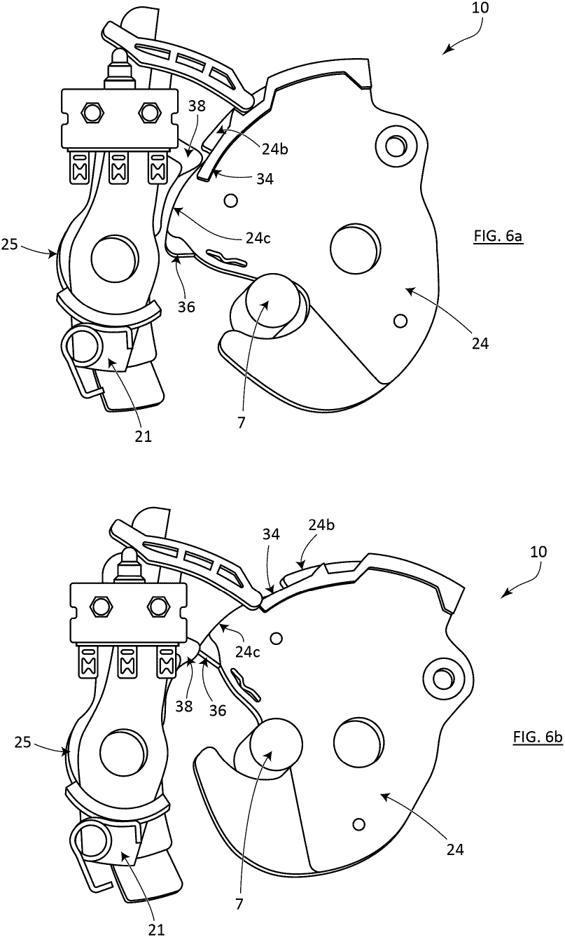

It should be recognised that when the abutment 38 of the pawl 25 is traveling along the ratchet surface 24b on the cam ratchet portion 24c between the notches 34, 36, the friction provided by the spring element 17 maintains contact of the end 60 with the cam surface 24a while the pawl 25 moves against the bias of the pawl bias element 15. In this manner, the pawl 25 can move relative to the position of the pawl lever 21 (e.g. counterclockwise about the pivot 26), see FIGS. 6a, 6b, and 3b

FIG. 5 provides an example table showing various example pawl lever active switch travel ranges r1, r2, r3, r4 of the travel D of the switch 14b for the various states OP1, OP2, TPP, e.g. when the switch 14b is in the travel depth D range r3 of 7.5 mm to 8 mm, the switch 14b is deemed to be in the secondary state OP2, e.g. when the switch 14b is in the travel depth D range r2 of 9.2 mm to 9.7 mm, the switch 14b is deemed to be in the secondary state OP2. Also recognized that the range wr1 of greater than 9.7 mm the pawl lever 21 is deemed in the primary position P1, while in the range r4 of 8.2-9.0 mm the pawl lever 21 is deemed in the secondary position P2 of the latch 10. Also considered is the travel range when the pawl lever 21 is in the open position P3.

FIG. 7 shows various latch states 10a (e.g. door open), 10b (e.g. secondary latch), 10c (e.g. Cinching from secondary to primary. Pawl back to open direction. Pawl lever keep at Secondary position), 10d (e.g. overcinch), 10e (e.g. Cinching finish. Pawl engage to Primary. Pawl lever engage to active Primary-SW) and the corresponding switch states OP1, OP2. In this example, the switch 14b (see FIGS. 3a, 3b, 3c, 3d) have both the switch states OP1 and OP2 as ON to signify that the closure latch 10 is open. When the switch state OP1 is ON and the switch state OP2 is OFF, this can signify that the latch is in the secondary position, as well as that the cinching operation (from secondary to primary position is yet to finish). Once cinching is complete (e.g. during over cinch and cinch completion), the travel distance of the switch 14b provides for both the switch states OP1 and OP2 as OFF, thus the switch is in the TPP state signifying a closed and cinched latch 10. Also shown are the switch states 10f (SW OP1 primary latch) and 10 g (SW OP2 secondary latch).

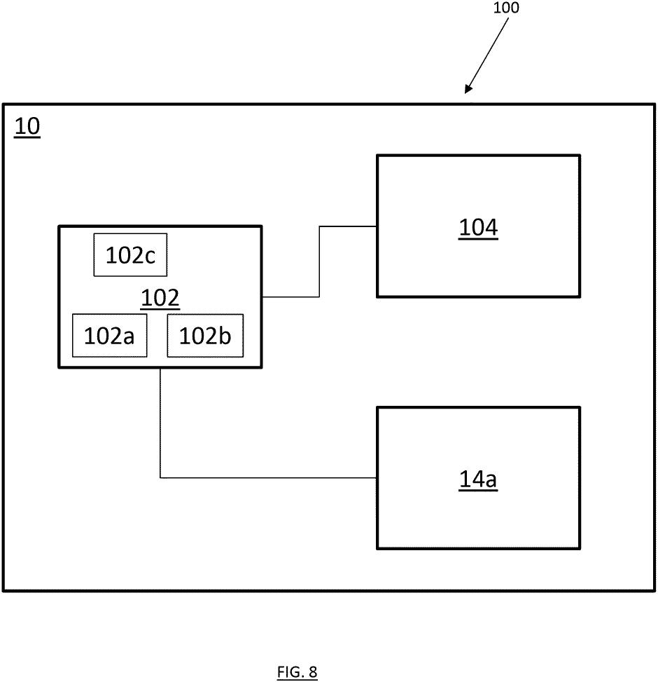

Referring to FIG. 8, shown a sensing system 100 as a high level block diagram showing a controller 102 (e.g. a control circuit) which can control various actuators (e.g. rotary actuator system 16 containing one or more motors / actuators 104 coupled to the ratchet 24 and/or the pawl 25)) based on a position of the closure panel 6 detected using the position sensor 14a and associated switch 14b. The position sensor(s) 14a can detect the absolute position of the closure panel 6, e.g. at one or more positions, based on the states OP1, OP2, TTP of the switch 14b. It is recognised that the latch 10 (e.g. latch assembly 10) can include the controller 102 as shown, or the controller 102 could be located external to the latch housing 14. Further, it is recognised that the latch 10 could be embodied as an elatch 10 for some or all of the latching / cinching functions. Alternatively, the latch 10 could be embodied as a mechanical latch for some or all of the latching / cinching functions.

Referring again to FIG. 8, the controller 102 has a computer processor 102a for processing /executing a set of stored instructions, a memory 102b for storing the instructions, and an interface 102c for sending / receiving signals (e.g. voltage measurements, current measurements, resistance measurements) to and from the other components of the position detection system 100 (e.g. actuator(s) 104 and position sensor(s) 14a).

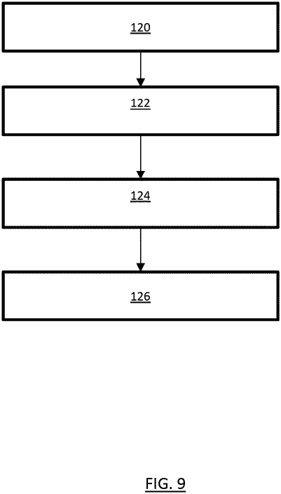

Referring to FIGS. 2, 9, shown is are example operations of the sensing system 100. At step 120, the switch 14b signals to the controller 102 that the ratchet 24 is in the secondary latched state OP2 (see FIG. 3c), once moved from the open state TPP (see FIG. 3d). As such, at step 122, the controller 102 can signal operation of the motor 104 of the cinch in order to rotate the ratchet 24 from the secondary position to the primary position. Once the ratchet 24 reaches the primary position (see FIG. 3b), then the same switch 14b sends a signal at step 124 that the ratchet 24 is in the primary position and thus the controller 102 can act to turn off the motor 104 at step 126. Similarly, the switch 14b of the position sensor 14a can indicated to the controller 102 when the ratchet 24 has moved from the primary position (state OP1 as ON as well as OP2 is ON) to the secondary position (state OP1 as ON with OP1 as OFF) and then finally to the open position (state TPP - e.g. where both OP1 and OP2 are indicated as OFF).

It is recognised that an advantage to the above system 100 is that a common (e.g. shared) position sensor 14a can be used to indicate that the latch 10 is in the secondary position and the primary position. In other words, a common position sensor 14a can be used to indicate (e.g. sense) different positions of the latch 10.

The various illustrative logical blocks, modules, and circuits described in connection with the embodiments disclosed herein (e.g. the controller 102, the control circuit 94, etc.) can be implemented or performed with a general purpose processor, a digital signal processor (DSP), an ASIC, a FPGA or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices (i.e. computer memory) for storing data, e.g., magnetic, magneto-optical disks, or optical disks. Information carriers suitable for embodying computer program instructions and data include all forms of non-volatile memory, including by way of example, semiconductor memory devices, e.g., electrically programmable read-only memory or ROM (EPROM), electrically erasable programmable ROM (EEPROM), flash memory devices, and data storage disks (e.g., magnetic disks, internal hard disks, or removable disks, magneto-optical disks, and CD-ROM and DVD-ROM disks). The processor and the memory can be supplemented by, or incorporated in special purpose logic circuitry.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Those of skill would further appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of claims exemplified by the illustrative embodiments. A software module may reside in random access memory (RAM), flash memory, ROM, EPROM, EEPROM, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. In other words, the processor and the storage medium may reside in an integrated circuit or be implemented as discrete components.

Computer-readable non-transitory media (e.g. computer memory) includes all types of computer readable media, including magnetic storage media, optical storage media, flash media and solid state storage media. It should be understood that software can be installed in and sold with a central processing unit (CPU) device. Alternatively, the software can be obtained and loaded into the CPU device, including obtaining the software through physical medium or distribution system, including, for example, from a server owned by the software creator or from a server not owned but used by the software creator. The software can be stored on a server for distribution over the Internet, for example.

We claim:

1. A latch for a closure panel of a vehicle comprising:
a housing;
a ratchet pivotally mounted the housing for moving between an open position and a primary position;
a pawl pivotally mounted on the housing, the pawl biased towards the ratchet for holding the ratchet in a secondary position and in the primary position, the secondary position located between the open position and the primary position; and
a position sensor for detecting a first position of the ratchet when at the primary position as well as a second position when the ratchet is at the secondary position.

2. The latch of claim 1 further comprising a pawl lever coupled to the pawl, the pawl lever having a cam lever arm positioned adjacent to a cam surface of the ratchet and a switch of the position sensor.

3. The latch of claim 2, wherein the cam surface has different surface portions associated with different operational states of the switch.

4. The latch of claim 3, wherein movement of the cam lever arm along the cam surface causes the switch to change from one operational state to another operational state of the different operational states.

5. The latch of claim 2, wherein the pawl lever moves relative to the pawl about a common pivot.

6. The latch of claim 2, wherein the cam lever arm is biased into contact at an end with cam surface by a pawl biasing element as the ratchet moves between the open position and the primary position.

7. The latch of claim 5 further comprising a pawl lever element providing friction between the pawl lever and the pawl in order to encourage contact between the cam lever arm and the cam surface when the pawl rotates about the common pivot.

8. The latch of claim 2, wherein the cam lever arm maintains contact with the cam surface while the pawl moves against a pawl biasing element as the ratchet moves from the secondary position to the primary position.

9. The latch of claim 1 further comprising an actuator, such that operation of the actuator is influenced by a first position signal generated by the position sensor and by a second position signal generated by the position sensor.

10. The latch of claim 9, wherein the first position signal indicates the ratchet is at the secondary position and the second position signal indicates the ratchet is at the primary position.

11. A method for operating a latch of a vehicle closure panel, the latch having a position sensor, the method comprising the steps of:
using the position sensor to sense a secondary position of a ratchet of the latch; and
using the same sensor to sense a primary position of the ratchet.

12. The method of claim 11 further comprising coupling a pawl lever to the pawl, whereby the pawl lever has a cam lever arm positioned adjacent to a cam surface of the ratchet and a switch of the position sensor.

13. The method of claim 12, wherein the cam surface has different surface portions associated with different operational states of the switch.

14. The method of claim 13 further comprising movement of the cam lever arm along the cam surface causes the switch to change from one operational state to another operational state of the different operational states.

15. The method of claim 12 further comprising the pawl lever moving relative to the pawl about a common pivot.

16. The method of claim 12 further comprising biasing the cam lever arm into contact at an end with the cam surface by a pawl biasing element as the ratchet is being moved between the open position and the primary position.

17. The method of claim 15 further comprising inducing friction by a pawl lever element between the pawl lever and the pawl in order to encourage contact between the cam lever arm and the cam surface when the pawl rotates about the common pivot.

18. The method of claim 12 further comprising maintaining contact with the cam surface while the pawl moves against a pawl biasing element as the ratchet moves from the secondary position to the primary position.

19. The method of claim 11 further comprising operating an actuator influenced by a first position signal when generated by the position sensor and by a second position signal when generated by the position sensor.

20. The method of claim 19, wherein the first position signal indicates the ratchet is at the secondary position and the second position signal indicates the ratchet is at the primary position.
